(19) United States
(12) Patent Application Publication
(10) Pub. No.: US 2005/0171325 A1
(43) Pub. Date: Aug. 4, 2005

(54) Cement additive

(75) Inventors: Tatsuya Matsui, Kawasaki-shi (JP); Akinori Itoh, Tokyo (JP); Eijiro Yoshimatsu, Tokyo (JP)

Correspondence Address: OLIFF & BERRIDGE, PLC, P.O. BOX 19928, ALEXANDRIA, VA, 22320, US

(73) Assignee: NOF Corporation, Tokyo (JP)

(21) Appl. No.: 10/518,522

(22) PCT Filed: Jul. 2, 2003
(86) PCT No.: PCT/JP03/08417

(30) Foreign Application Priority Data
Jul. 4, 2002 (JP) 2002-195995

(51) Int. Cl. C08G 63/02

(52) U.S. Cl. 528/272

(57) ABSTRACT

An additive for cement comprising the following component (A) is provided. (A) A polycarboxylic acid series esterified copolymer obtained by esterifying a part or whole of carboxylic acid groups of a polycarboxylic acid series copolymer having a polyoxyalkylene chain with a derivative of an alcohol having a polyoxyalkylene chain and represented by the following formula (1) (R¹ represents a group of a heterocyclic ring having a nitrogen atom or a group represented by the following formula (2). R² and R³ represent hydrocarbon groups having 1 to 6 carbon atom(s), respectively and independently. “AO” represents an oxyalkylene group having 2 to 4 carbon atoms. “n1” represents an average mole number of addition of the oxyalkylene group and 1 to 8.).

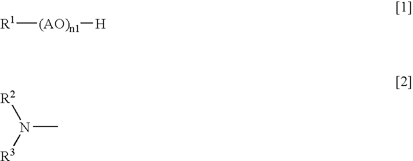

### BACKGROUND OF THE INVENTION

1. Field of the Invention

The present invention provides an additive for cement, and more specifically, to an additive for cement for preventing reduction of fluidity over time (referred to as “slump loss” below) of a cement composition such as cement paste, cement grout, cement mortar and concrete and for lowering viscosity of cement composition to improve working efficiency of cement composition.

2. Related Art Statement

Various kinds of cement dispersants have been used for improving the fluidity of a cement composition. When a cement dispersant is used to produce a hydraulic composition with water highly reduced, however, the slump loss of the composition is generally considerable to deteriorate the working efficiency and ease of execution.

It has thus been proposed to use a water soluble copolymer, having a function of preventing slump loss by itself, as a cement dispersant for preventing slump loss. Such water soluble copolymers include a copolymer of maleic anhydride and an alkenyl ether and the derivatives of the copolymer (see Japanese patent publication S63-285140A, H02-163108A, H04-175253A and H04-175254A). When this kind of water soluble copolymer is used as a cement dispersant to sufficiently prevent the slump loss, however, setting time of the composition becomes longer.

For solving the above problems, it has been proposed that the above copolymer of an alkenyl ether and maleic anhydride are esterified with an alcohol having an alkenyl group or with an alcohol having nitrogen group (Japanese patent publication H06-271347A and H06-298556A). According to the copolymers, the slump loss can be effectively prevented and the setting time can be shortened.

### SUMMARY OF THE INVENTION

Cement compositions are placed in sites under high temperature environment more and more due to recent warming on the earth. Under high temperature environment, slump loss becomes more considerable, which is different from the behavior of slump loss at low or ambient temperature. Even if the copolymers described above are added to a cement composition, it may be difficult to sufficiently prevent the slump loss.

Further, a cement composition is flown into a site by compression with a pump and processed by hands in many sites. During the flowing of the composition by compression with a pump and the processing of flown composition by hands, it has been pointed out that the working efficiency is low due to the high viscosity of the composition.

An object of the present invention is to provide a cement additive for preventing slump loss under high temperature condition over a long period of time and for lowering the viscosity of a produced cement composition to improve working efficiency of the cement composition.

The present invention provides an additive for cement comprising the following component (A).

(A) A polycarboxylic acid series esterified copolymer obtained by esterifying a part or whole of carboxylic acid groups contained in a polycarboxylic acid series copolymer having a polyoxyalkylene chain with a derivative of an alcohol having polyoxyalkylene and represented by the following formula (1).

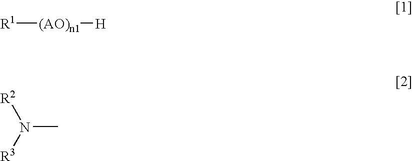

R¹ represents a group of a heterocyclic ring having a nitrogen atom or a group represented by the above formula (2). R² and R³ represent hydrocarbon groups having 1 to 6 carbon atom(s), respectively and independently. “AO” represents an oxyalkylene group having 2 to 4 carbon atoms, n1 represents an average mole number of addition of the oxyalkylene group and 1 to 8.

The inventors have found that slump loss at high temperature can be prevented over a long period of time and the viscosity of a cement composition produced can be lowered to improve working efficiency of the cement composition, by esterifying a part or whole of carboxylic acid groups of a polycarboxylic acid series copolymer having a polyoxyalkylene chain with a derivative of an alcohol having polyoxyalkylene and represented by the formula (1). Particularly, it is found that slump loss at high temperature can be considerably reduced by lowering the average mole number “n1” of addition of the oxyalkylene group (AO) to 8 or lower, in the derivative (formula (1)) of an alcohol having an polyoxyalkylene used for esterifying carboxylic groups of the polycarboxylic acid series copolymer. Further, the advantageous effects of prevention of slump loss at high temperature is difficult to predict based on experimental results of slump loss at ambient temperature (20° C.).

### PREFERRED EMBODIMENTS OF THE INVENTION

The additive for cement of the present invention may be applied to hydraulic cement compositions such as cement paste, cement grout, mortar and concrete. Particularly, the inventive additive may be added into a concrete composition produced using a high performance water reducing agent or a high performance AE water reducing agent as a cement dispersant, during mixing step. In this case, slump loss can be prevented and working efficiency and ease of execution at working sites can be improved while maintaining high fluidity.

According to the cement additive of the present invention, the fluidity of a cement composition, such as cement paste, mortar and concrete, direct after the mixing step can be improved, even when the temperature of the cement composition is high. The additive further has excellent water reducing property and superior slump retention effect, so that the resultant concrete has a low viscosity and excellent working efficiency. The cement additive of the present invention thus may be used as a water reducing agent for a ready mix concrete, a high performance AE water reducing agent or a fluidizing agent, or a high performance water reducing agent used for producing concrete secondary products to result in improvement of working efficiency and ease of execution at sites of civil engineering and construction.

The esterified polycarboxylic acid series copolymer of (A) component is produced by esterifying a polycarboxylic acid series copolymer, which contains a derivative of an alcohol having polyoxyalkylene and an unsaturated mono- or unsaturated polyvalent carboxylic acid series compound as essential components. The kind of the polycarboxylic acid series copolymer is not particularly limited, as far as the copolymer has properties required for a cement additive.

The polycarboxylic acid series copolymer may preferably the followings.

A copolymer of (meth)acrylic acid-alkyl polyoxyalkylene (meth)acrylate compound, a copolymer of monoalkyl monoalkenyl ether of a polyoxyalkylene compound-maleic anhydride, a copolymer of styrene-alkyl polyoxyalkylene maleate, a copolymer of monoalkenyl ether of a polyoxyalkylene compound-maleic acid, (meth)acrylic acid-(meth)acryl amide of alkyl polyoxyalkylene compound, and the salts of the above listed copolymers. The expression of “(meth)acrylic” means “acrylic” or “methacrylic”.

According to the component (A), a part or whole of carboxylic acid sites of the polycarboxylic acid series copolymer is esterified with the derivative of an alcohol having polyoxyalkylene and represented by formula (1).

Concerning a part of carboxylic acid sites of the polycarboxylic acid series copolymer esterified with the derivative of alcohol having polyoxyalkylene and represented by formula (1), only at least a part of carboxylic acid sites of the copolymer needs to be esterified. On the viewpoint of preserving fluidity, 20 percent or more of carboxylic acid sites may preferably be esterified. The ratio of esterified carboxylic sites with respect to total number of carboxylic sites can be controlled by adjusting charged ratio of the derivative of alcohol having polyoxyalkylene and represented by formula (1) with respect to the number of polycarboxylic sites.

In the formula (1), R¹ represents a heterocyclic ring having a nitrogen atom or a group represented by the formula (2).

In the formula (1), the heterocyclic ring having a nitrogen atom and represented by R¹ includes pyrrole, imidazole, pyrazole, 3-pyrroline, pyrrolidine, pyridine, pyrimidine, piperazine, piperidine, 4-piperidino-piperidine, 4-(1-pyrrolidinyl)piperidine, quinazoline, quinoline, isoquinoline, carbazole or the like. The above listed heterocyclic rings may be used alone or in combination.

In formula (2), the hydrocarbon having 1 to 6 carbon atom(s) of R² or R³ includes aliphatic and saturated hydrocarbon groups such as methyl, ethyl, propyl, isopropyl, butyl, isobutyl, sec-butyl, tert-butyl, pentyl, isopentyl, neopentyl and hexyl groups; aliphatic and unsaturated hydrocarbon groups such as allyl and methallyl groups; alicyclic and saturated hydrocarbon groups such as cyclohexyl group; alicyclic and unsaturated hydrocarbon groups such as cyclopentenyl and cyclohexenyl groups; and aromatic hydrocarbon groups such as phenyl and benzyl groups. The above listed hydrocarbon groups may be used alone or in combination. R² and R³ may be the same or different with each other. Each of R² and R³ may most preferably be a hydrocarbon group having 1 to 4 carbon atom(s).

In the formula (1), the oxyalkylene group represented by “AO” and having 2 to 4 carbon atoms includes oxyethylene, oxypropylene, 1,2-oxybutylene, oxytetramethylene groups, and may preferably be oxyethylene group. The oxyalkylene group may be used alone or in combination. When two or more of the oxyalkylene groups are used, the groups may be added in random or block addition.

According to the present invention, the average mole number “n1” of addition of the oxyalkylene group is limited in a range of 1 to 8. It is thus possible to considerably reduce slump loss of the cement composition at high temperature. On the viewpoint, “n1” may preferably be 6 or lower, more preferably be 5 or lower and most preferably be 4 or lower.

According to the component (A), a part or whole of the carboxylic acid sites of the polycarboxylic acid series copolymer may be esterified with the derivative of alcohol having polyoxyalkylene and represented by formula (1), using a esterifying catalyst. Such esterifying catalyst includes hydroxides of alkali metals such as lithium hydroxide, sodium hydroxide, potassium hydroxide; hydroxides of alkaline earth metals such as calcium hydroxide; basic catalysts such as sodium methoxide; and a solid acid catalysts such as p-toluene sulfonic acid.

The additive composition for cement according to the present invention may contain a component (B), in addition to the component (A), so that the viscosity of the cement composition can be further reduced.

The component (B) is the derivative, represented by formula (1), of alcohol having polyoxyalkylene.

The weight ratio of the components (A):(B) is 95:5 to 100:0, and may preferably be 97:3 to 100:0.

When the component (A) is produced, an excessive amount of the compound represented by formula (1) may be added so that the component (B) is left in the resultant cement additive composition. Alternatively, after the component (A) is produced, the component (B) may be added to the cement additive.

The additive composition for cement according to the present invention may contain a component (C), a polycarboxylic acid series copolymer having a polyoxyalkylene chain used as a cement additive, in addition to the component (A). It is thus possible to improve the initial fluidity of the cement composition.

The component (C) represents a polycarboxylic acid series copolymer having polyoxyalkylene chain which is not esterified with the derivative of alcohol having polyoxyalkylene.

The polycarboxylic acid series copolymer means a copolymer containing a polyoxyalkylene derivative and an unsaturated mono- or polyvalent carboxylic acid series compound as essential components. The kind of the polycarboxylic acid series copolymer is not particularly limited, as far as the copolymer has properties required as a cement additive. Most preferred copolymers will be described later.

The polycarboxylic acid series copolymer represented by the component (C) is the same kind of material as the copolymer used for producing the component (A) before the esterification. It is not required that both of the component (C) and the copolymer before esterification used for producing the component (A) are the same.

The weight ratio of the components (A) and (C) ((A):(C)) is 20:80 to 100:0, and may preferably be 30:70 to 80:20.

Further, the additive composition for cement according to the present invention may contain all the components (A), (B) and (C).

The weight ratio of the components (A), (B) and (C) ((A):(B):(C)) is 20:1:79 to 10:0:0, and may preferably be 30:1:69 to 80:0:20.

According to a preferred embodiment, the molecular weight of the polyoxyalkylene site of the polycarboxylic acid copolymer, which is a material for the component (A), and the amine value of the component (A) satisfy the relationship of formula (3a). It is thus possible to obtain excellent initial fluidity and performance as a fluidity preserving agent in good balance.
Molecular weight of polyoxyalkylene site of polycarboxylic acid copolymer/amine value of component (A)=15 to 150 (3a)

When the inventive composition contains the components (A) and (B), it is preferred that the molecular weight of the polyoxyalkylene site of the polycarboxylic acid copolymer and the amine value of a mixture of the components (A) and (B) satisfy the relationship of formula (3b).
Molecular weight of polyoxyalkylene site of the polycarboxylic acid copolymer/amine value of a mixture of components (A) and (B)=15 to 150 (3b)

When the inventive composition contains the components (A), (B) and (C), it is preferred that the molecular weight of the polyoxyalkylene site of the polycarboxylic acid copolymer and the amine value of a mixture of the components (A), (B) and (C) satisfy the relationship of formula (3c).
Molecular weight of polyoxyalkylene site of the polycarboxylic acid copolymer/amine value of a mixture of components (A), (B) and (C)=15 to 150 (3c)

When the inventive composition contains the components (A) and (C), it is preferred that the molecular weight of the polyoxyalkylene site of the polycarboxylic acid copolymer and the amine value of a mixture of the components (A) and (C) satisfies the relationship of formula (3d).
Molecular weight of polyoxyalkylene site of the polycarboxylic acid copolymer/amine value of a mixture of components (A) and (C)=15 to 150 (3d)

According to the present invention, the molecular weight of the polyoxyalkylene site of the polycarboxylic copolymer is a molecular weight of a polyoxyalkylene compound used as a material for producing the component (A). The amine value is a representation of mole number of amine groups with respect to the whole product represented by equivalent weight (mg) of potassium hydroxide.

It is possible to further improve the water reducing property as a cement additive, by adjusting the ratio of molecular weight of the polyoxyalkylene site of the polycarboxylic acid copolymer/the amine value to 15 or higher (more preferably 20 or higher).

It is possible to further improve the performance of the additive as a fluidity preserving agent and further lower the viscosity of the raw cement composition, by adjusting the ratio of molecular weight of the polyoxyalkylene site of the polycarboxylic acid copolymer/the amine value to 150 or lower (more preferably 130 or lower).

When an optional component is contained in the additive composition for cement other than the components (A), (B) and (C), the amine value can be measured and calculated after the components (A), (B) and (C) are extracted from the additive composition for cement.

If it is difficult to extract the components (A), (B) and (C) from the additive composition for cement, the amine value can be obtained by the following calculation.

That is, water content is removed from the additive composition for cement to obtain dried matter, which is then subjected to analysis using NMR and gel permeation chromatography to calculate the ratio of each component. The contents of the components (A), (B) and (C) are calculated, respectively, based on the above results. Further, the amine value of the additive composition for cement (dried matter) is measured. The amine value is then calculated according to the following formula.
The amine value=Amine value of dried matter×(total weight of components (A), (B) and (C))/total weight of dried matter

The copolymer constituting the component (A) or (C) may more preferably be the following.

The polycarboxylic acid series copolymer constituting the component (A) or (C) may preferably be a copolymer comprising, as essential components,
(a) a polyoxyalkylene derivative represented by the following formula (4),
   R⁴O(AO)ₙ₂R⁵ (4)

(In the formula, R⁴ represents an unsaturated hydrocarbon group having 2 to 8 carbon atoms, R⁵ represents a saturated hydrocarbon group having 1 to 8 carbon atom(s), “AO” represents oxyalkylene group having 2 to 4 carbon atoms, and “n2” represents an average mole number of addition of the oxyalkylene group and 10 to 100) and
(b) an unsaturated polyvalent carboxylic acid series compound.

A single type of the compound represented by the formula (4) can be used in the resulting copolymer. Alternatively, different compounds represented by the formula (4), in which R⁴, R⁵, “AO” or “n2” is different with each other, can be mixed for producing a copolymer, In the formula (4), the unsaturated hydrocarbon group having 2 to 8 carbon atoms represented by R⁴ includes aliphatic unsaturated hydrocarbon groups such as vinyl, allyl, methallyl, 1-methyl-1-butenyl, 2-methyl-2-propenyl groups; and alicyclic unsaturated hydrocarbon group such as cyclopentenyl and cyclohexenyl groups. The hydrocarbon groups may be used alone or in combination. Allyl and methallyl groups are particularly preferred. Methallyl group is most preferred for improving the initial fluidity of raw cement composition.

In the formula (4), the saturated hydrocarbon group having 1 to 8 carbon atom(s) represented by R⁵ includes an aliphatic saturated hydrocarbon group such as methyl, ethyl, propyl, isopropyl, butyl, isobutyl, sec-butyl, and tert-butyl groups. The hydrocarbon group may be used alone or in combination. R⁵ may more preferably be hydrogen atom or a saturated hydrocarbon group having 1 to 4 carbon atom(s). R⁵ may most preferably be methyl group or hydrogen atom.

In the formula (4), the oxyalkylene group having 2 to 4 carbon atoms represented by “AO” includes oxyethylene, oxypropylene, 1,2-oxybutylene and oxytetramethylene groups. Two or more oxyalkylene groups may be added with each other in random or block addition. The average mole number “n2” of addition of oxyalkylene groups is 10 to 100 and may preferably be 20 to 50. It is thus possible to further improve the water reduction property of the additive for cement.

According to a preferred embodiment, oxyethylene group occupies 50 mole percent or more, more preferably 80 mole percent or more, of oxyalkylene group constituting “AO”. It is thus possible to further improve the water solubility and water reducing property of the inventive additive.

Unsaturated and polyvalent carboxylic acid series compound is not particularly limited, as far as the compound can co-polymerize with the polyoxyalkylene derivative to provide the polycarboxylic acid series copolymer. The unsaturated polyvalent carboxylic acid compounds include di-carboxylic acid monomer such as maleic acid, itaconic acid and fumaric acid, and the anhydride or salt (for example, alkali metal salt, alkaline earth metal salt and ammonium salt) of the dicarboxylic acid monomer.

According to a preferred embodiment, the unsaturated and polyvalent carboxylic acid series compound is a maleic acid series compound, and more preferably be maleic acid, maleic anhydride, the salt of maleic acid or the mixture thereof.

The salt of maleic acid includes alkali metal salts such as mono-lithium salt, di-lithium salt, mono-sodium salt, di-sodium salt, mono-potassium salt, di-potassium salt; alkaline earth metal salts such as calcium salt and magnesium salt; and ammonium salts such as ammonium salt and di-ammonium salt. The compounds may be used alone or in combination.

When (a) and (b) are copolymerized, still another monomer capable of copolymerization may be contained. Such monomer includes styrene, acrylic acid, methacrylic acid, sodium allyl sulfonate, allyl sulfonate, sodium methallyl sulfonate, methallyl sulfonate, vinyl acetate and allyl acetate. The additional monomer may be used alone or in combination. The additional monomer may preferably be contained in a content of 3 to 40 mole percent in the copolymer, on the purpose of improving initial fluidity.

The molar ratio of (a) and (b) may preferably be 1:1 to 1:3 and more preferably be 1:1 to 1:2 in the polycarboxylic acid series copolymer.

The weight average molecular weight of the polycarboxylic acid series copolymer may preferably be 5000 to 50000.

(a) and (b) may be polymerized using a polymerization initiator including peroxide series initiators such as benzoyl peroxide; azo-series polymerization initiators such as 2,2′-azobisisobutyronitrile; and persulfate series initiators such as ammonium persulfate. Further, a chain transfer agent may be optionally used for the polymerization.

The additive for cement according to the present invention may be added to cement pastes, which are compositions of various kinds of cements including portland cements such as ordinary cement, high-early-strength cement, moderate-heat cement and belite cement and blended cements produced by adding blast furnace slag, fly ash, silica fume or limestone to these portland cements. Further, the additive of the present invention may be added to mortar produced by adding fine aggregate such as river sand, mountain sand and beach sand to the cement paste. Further, the additive of the present invention may be added to concrete produced by adding coarse aggregate such as river gravel, crushed stone and lightweight aggregate to the above mortar.

The inventive additive may be used by adding the additive into water used for mixing of mortar or concrete in advance, or by adding the additive into the composition simultaneously with water, or by adding the additive after the addition of water and before the end of mixing step. Further, the additive may be added to cement composition after the mixing of the composition is completed.

The additive for cement according to the present invention may be added to various kinds of cements, preferably in an amount of 0.01 to 2 weight percent and more preferably be in 0.05 to 1 weight percent. When the amount of the additive to cement is lower than 0.01 weight percent, the fluidity of the cement composition may be insufficient to prevent the effects of the present invention. When the amount of the additive to cement is higher larger than 2 weight percent, the separation of materials may occur or the setting time may be considerably longer.

The additive for cement according to the present invention may be used simultaneously with another additive for cement, as far as the effects of the present invention is not prevented.

Such another additive includes the other water reducing agents such as the salt of condensation product of naphthalene sulfonic acid and formaldehyde, the salt of condensation product of melamine sulfonic acid and formaldehyde, the salt of lignosulfonic acid and the salt of condensation product of aromatic amino sulfonic acid and formaldehyde; air-entraining agent; antifoaming agent; separation reducing agent; retarder; accelerator; inflating agent; dry shrinkage reducing agent; and preservative.

### EXAMPLES

The present invention will be described below referring to the following examples.

Table 1 shows the structures of compounds represented by formula 4 used in synthetic examples 1 to 9, the other monomers, maleic acid series compounds and the compositions of the monomers in the synthetic examples 1 to 9. In table 1, all the mole numbers of the compounds represent the molar ratios thereof.

TABLE1

| | | | | the other | |
|---|---|---|---|---|---|
| | synthetic | | | monomers | maleic acid series compound |
| | example | copolymer | compound represented by formula (4) (mole) | (mole) | (mole) |
| Polycarboxylic | 1 | a | H₂C═CHCH₂O(C₂H₄O)₃₃CH₃ (1.0) | — | maleic anhydride (1.1) |
| acid series | 2 | b | H₂C═CHCH₂O(C₂H₄O)₄₅CH₃ (1.0) | — | maleic anhydride (1.2) |
| copolymer used | 3 | c | H₂C═CHCH₂O(C₂H₄O)₁₀CH₃ (1.0) | — | maleic anhydride (1.0) |
| as cement | 4 | d | H₂C═CHCH₂O(C₃H₆O)₈(C₂H₄O)₁₆C₄H₉ | — | maleic anhydride (1.0) |
| additive | | | (1.0) | | |
| | 5 | e | H₂C═CHCH₂O[(C₃H₆O)₂/(C₂H₄O)₃₀]H | — | maleic acid (1.5) |
| | | | (1.0) | | neutralized after polymerization |
| | | | | | with NaOH |
| | 6 | f | H₂C═C(CH₃)CH₂O(C₂H₄O)₂₃CH₃ | — | maleic anhydride (1.8) |
| | | | (1.0) | | |
| | 7 | g | H₂C═CHCH₂O(C₂H₄O)₃₃CH₃ (1.0) | vinyl | maleic anhydride (1.1) |
| | | | | acetate | |
| | | | | (0.15) | |
| | 8 | h | H₂C═CHCH₂O(C₂H₄O)₃₃CH₃ | vinyl | maleic anhydride (1.3) |
| | | | (1.0) | acetate | neutralized with NaOH |
| | | | | (0.30) | after polymerization |

| | | |
|---|---|---|
| 9 | i | Methacrylic acid-methoxy polyethylene glycol monomethacrylate average mole number of |
| | | addition of ethylene oxide is 9, copolymer is not completely neutralized to a pH of 6 |

### Synthetic Example 1

5-liter pressurized reactor was charged with 64 grams of methanol and 2.0 grams of sodium methoxide as a catalyst and the air was replaced with nitrogen gas. 2904 grams of ethylene oxide was then gradually supplied into the reactor at a gauge pressure of 0.05 to 0.5 MPa to perform addition reaction at a temperature of 100 to 120° C. The reactor was cooled to 50° C. after the reaction was terminated. After 112 grams of potassium hydroxide was supplied into the reactor and the air was replaced with nitrogen gas, 153 grams of allyl chloride was gradually added to the reaction mixture while stirring at 80° C. The reaction mixture was stirred for 6 hours until the reaction is terminated and then neutralized with hydrochloric acid. The resulting salt was removed as a byproduct to obtain the polyoxyalkylene compound represented by the formula (4) and shown in table 1.

1524 grams (1 mole) of the above synthesized compound (4), 107.8 grams (1.1 mole) of maleic anhydride and 300 grams of toluene were weighed and charged into a 3-liter flask equipped with a mixer, thermometer, tube for introducing nitrogen gas, dropping funnel and reflux condenser. Under nitrogen atmosphere, 13.1 grams of 2,2′-azobisisobutyronitrile as a polymerization initiator was dissolved into 262 grams of toluene and dropped into the flask at 85±2° C. over 3 hours. After the dropping was terminated, the mixture was left for the reaction for additional 3 hours. Toluene was then removed under reduced pressure to obtain a copolymer “a”. The thus obtained copolymer “a” has a weight average molecular weight of 20200 and a kinematic viscosity of 224 mm²/s at 100° C.

### Synthetic Example 2

The polyoxyalkylene compound shown in table 1 was synthesized according to the same procedure as the synthetic example 1. 2052 grams (1 mole) of the polyoxyalkylene compound and 117.6 grams (1.2 mole) of maleic anhydride were weight and charged in a 5-liter flask equipped with a mixer, thermometer and a tube for introducing nitrogen gas. 14.0 grams of benzoyl peroxide as an initiator was added to the mixture in batch at a temperature of 50° C. or lower to perform polymerization at 85±2° C. for 5 hours to obtain a copolymer “b”. The copolymer “b” had a weight average molecular weight of 23700 and a kinetic viscosity of 527 mm²/s at 100° C.

### Synthetic Example 3

The polyoxyalkylene compound shown in table 1 was synthesized according to the same procedure as the synthetic example 1. 1024 grams (2 mole) of the polyoxyalkylene compound, 196 grams (2 mole) of maleic anhydride, and 300 grams of toluene were weighed and charged into the reactor same as the synthetic example 1. 12.1 grams of benzoyl peroxide as initiator was dissolved in 300 grams of toluene and dropped into the mixture under nitrogen atmosphere for copolymerization. Toluene was then removed to obtain a copolymer “c”. The copolymer “c” had a weight average molecular weight of 21400 and a kinetic viscosity of 254 mm²/s at 100° C.

### Synthetic Example 4

The polyoxyalkylene compound shown in table 1 was synthesized according to the same procedure as the synthetic example 1. 1274 grams (1.0 mole) of the polyoxyalkylene compound, 98 grams (1.0 mole) of maleic anhydride, and 300 grams of toluene were weighed and charged into the reaction mixture as the synthetic example 1. 8.6 grams of tert-butyl peroxy-2-ethyl hexanoate was dissolved in 100 grams of toluene and dropped into the mixture under nitrogen atmosphere for copolymerization. Toluene was then removed to obtain a copolymer “d”. The copolymer “d” had a weight average molecular weight of 26500 and a kinetic viscosity of 198 mm²/s at 100° C.

### Synthetic Example 5

5-liter pressurized reactor was charged with 116 grams of allyl alcohol and 3.0 grams of sodium hydroxide as a catalyst and the air was replaced with nitrogen gas. 2640 grams of ethylene oxide and 228 grams of propylene oxide were then gradually supplied into the reactor at a gauge pressure of 0.05 to 0.5 MPa to perform addition reaction at a temperature of 100 to 120° C. The reactor was cooled to 50° C. after the reaction was terminated. After the reaction mixture was neutralized with hydrochloric acid, the resulting salt was removed as a byproduct to obtain the polyoxyalkylene compound represented by the formula (4) and shown in table 1.

1492 grams (1 mole) of the above synthesized compound (4), 147 grams (1.5 mole) of maleic anhydride and 410 grams of ion exchange water were weighed and charged into a 3-liter flask equipped with a mixer, thermometer, tube for introducing nitrogen gas, dropping funnel and reflux condenser. Under nitrogen gas atmosphere, 5.8 grams of ammonium persulfate as a polymerization initiator was dissolved into 164 grams of ion exchange water and dropped into the flask at 85±2° C. for 3 hours. After the dropping was terminated, the reaction mixture was left at 85±2° C. for 3 hours for the reaction. The thus obtained copolymer “e” had a weight average molecular weight of 15600. After aqueous solution of the copolymer “e” was obtained, 150 grams of 40% NaOH aqueous solution was added for neutralization to obtain 60% aqueous solution of the copolymer “e”.

### Synthetic Example 6

The polyoxyalkylene compound shown in table 1 was synthesized according to the same procedure as the synthetic example 1. 1098 grams (1.0 mole) of the polyoxyalkylene compound, 176.4 grams (1.8 mole) of maleic anhydride and 1275 grams of toluene were weighed and charged into the reaction mixture as the synthetic example 1. 8.2 grams of 2,2′-azobisisobutyronitrile was dissolved in 164 grams of toluene and dropped into the mixture under nitrogen atmosphere for copolymerization. Toluene was then removed to obtain a copolymer “f”. The copolymer “f” had a weight average molecular weight of 19400 and a kinetic viscosity of 340 mm²/s at 100° C.

### Synthetic Example 7

1524 grams (1 mole) of the polyoxyalkylene compound shown in table 1, 107.8 grams (1.1 mole) of maleic anhydride, 12.9 grams (0.15 mole) of vinyl acetate and 300 grams of toluene were weighed and charged according to the procedure in the synthetic example 1. 9.4 grams of benzoyl peroxide as an initiator was dissolved in 95 grams of toluene and dropped into the mixture under nitrogen atmosphere for copolymerization. Toluene was then removed to obtain a target copolymer “g”. The copolymer “g” had a weight average molecular weight of 19900 and a kinetic viscosity of 305 mm²/s at 100° C.

### Synthetic Example 8

1524 grams (1.0 mole) of the polyoxyalkylene compound shown in table 1, 127.4 grams (1.3 mole) of maleic anhydride, 25.8 grams (0.3 mole) of vinyl acetate and 300 grams of toluene were weighed and charged according to the procedure in the synthetic example 1. 13.1 grams of 2,2′-azobisisobutyronitrile as initiator was dissolved in 262 grams of toluene and dropped into the mixture under nitrogen atmosphere for copolymerization. Toluene was then removed to obtain a target copolymer “h”. The copolymer “h” had a weight average molecular weight of 23400 and a kinetic viscosity of 550 mm²/s at 100° C. The thus obtained copolymer “h” was dissolved into ion exchange water to obtain aqueous solution, to which 40% NaOH solution was added for neutralization.

### Synthetic Example 9

390 grams of isopropyl alcohol (referred to as “IPA” below) was charged into 1-liter flask equipped with a thermometer, mixer, dropping funnel, tube for introducing gas and reflux condenser. The inside of the flask was replaced with nitrogen with stirring and heated to boiling point under nitrogen atmosphere. Mixture of 133 grams of methoxy polyethylene glycol monomethacrylate (“NK-ester M-9G” supplied by SHIN-NAKAMURA CHEMICAL CO.,LTD; the average mole number of addition of ethylene oxide is 9), 27 grams of methacrylic acid, 2.44 grams of benzoyl peroxide and 240 grams of IPA was added over 120 minutes. After the addition, 0.49 grams of benzoyl peroxide dispersed into 10 grams of IPA and divided to two fractions was added to the mixture at an interval of 30 minutes After the addition of monomers was completed, the temperature was held at the boiling point for 120 minutes to complete the polymerization reaction. After that, sodium hydroxide solution was added to adjust the pH of the mixture, and IPA was distilled to obtain aqueous solution of a copolymer “i”.

TABLE 2

| | component (A) | | | |
|---|---|---|---|---|
| | polycarboxylic | | | |
| syn- | acid series | | | |
| thetic | copolymer | | | component (B) |
| ex- | used as cement | | compound represented | compound represented |
| am- | additive | | by formula (1) | by formula (1) |
| ple | (weight ratio) | | (weight ratio) | (weight ratio) |
| 10 | a | 91.8 | (C₂H₅)₂N(C₂H₄O)H | (C₂H₅)₂N(C₂H₄O)H |
| | | | 5.8 | 2.4 |
| 11 | a | 90.0 | (C₄H₉)₂N(C₂H₄O)₂H | (C₄H₉)₂N(C₂H₄O)2H |
| | | | 8.0 | 2.0 |
| 12 | a | 84.7 | (CH₃)₂N(C₂H₄O)₃H | (CH₃)₂N(C₂H₄O)₃H |
| | | | 7.0 | 3.3 |
| 13 | a | 52.0 | (CH₃)₂N(C₂H₄O)₃₃H | [symbol] |
| | | | 48.0 | |
| 14 | b | 96.2 | (CH₃)₂N(C₂H₄O)H | [symbol] |
| | | | 3.8 | |
| 15 | b | 81.6 | (C₂H₅)₂N(C₂H₄O)₃H | (C₂H₅)₂N(C₂H₄O)₃H |
| | | | 7.3 | 4.4 |
| 16 | b | 85.8 | (C₆H₅)₂N(C₂H₄O)₂H | (C₆H₅)₂N(C₂H₄O)₂H |
| | | | 12.2 | 2.0 |
| 17 | b | 66.4 | (C₄H₉)₂N(C₂H₄O)₂₃H | [symbol] |
| | | | 33.6 | |

TABLE 3

| | component (A) | | component (B) |
|---|---|---|---|
| | polycarboxylic acid series | compound represented | compound represented by |
| synthetic | copolymer used as | by formula (1) | formula (1) |
| example | cement additive (weight) | (weight ratio) | (weight ratio) |
| 18 | b 92.8 | 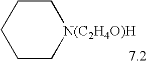 | None |
| 19 | f 83.4 | 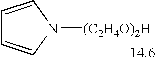 | 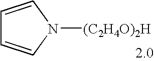 |
| 20 | g 90.4 | 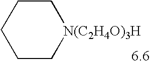 | 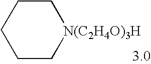 |
| 21 | c 72.8 | 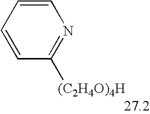 | None |

Tables 2 and 3 show compounds represented by formula (1) for the component “A”, polycarboxylic acid series copolymers, and compounds of the component “B” used for the synthetic examples 10 to 21.

### Synthetic Example 10

367 grams of the copolymer “a” and 23 grams of the compound represented by formula (1) and shown in table 2 were weighed and charged into a 2-liter flask equipped with a mixer, thermometer and tube for introducing nitrogen, and reacted under nitrogen gas at 100±2° C. for 8 hours to obtain the component “A”.

The whole of the component “A” and 10 grams of the component “B” shown in table 2 were weighed and mixed with stirring for 30 minutes at a temperature higher than the freezing point of the solution.

### Synthetic Examples 11 to 21

The copolymers shown in table 2 and compounds of the formula (1) were weighed and reacted under nitrogen atmosphere at 100±2° C. for 8 hours according to the same procedure as the synthetic example 10 to obtain the components (A).

“The compounds represented by formula (1)” used in the synthetic examples 18, 19, 20 and 21 were N-(2-hydroxyethyl) pipperidine (n11=), N-polyoxyethylene pyrrole (n1=2), N-polyoxyethylele pipperidine (n=3) and 2-polyoxyethylene pyrridine (n=4), respectively.

The whole of the component (A) and the component (B) shown in table 2 were weighed and mixed with stirring for 30 minutes at a temperature higher than the freezing point of each solution.

TABLE 4

| | | | | | molecular weight | | |
|---|---|---|---|---|---|---|---|
| | | | | | of polyoxyalkylene | | |
| | | | polycarboxylic | | chain of | | molecular |
| | | | acid series | | polycarboxylic | | weight of |
| | cement additive of the | | copolymer of | | acid series | amine | polyoxyalkylene |
| composition | present invention | | component (C) | | copolymer | value | chain/amine |
| example | (weight ratio) | | (weight ratio) | | of component (A) | (KOHmg/g) | value |
| 1 | synthetic example10 | 40 | a | 60 | 1524 | 15.9 | 96 |
| 2 | synthetic example11 | 80 | b | 20 | 1524 | 19.1 | 80 |
| 3 | synthetic example12 | 60 | c | 40 | 1524 | 20.5 | 74 |
| 4 | synthetic example13 | 50 | a | 50 | 1524 | 8.9 | 171 |
| 5 | synthetic example14 | 55 | b | 45 | 2052 | 14.8 | 126 |
| 6 | synthetic example15 | 70 | d | 30 | 2052 | 21.0 | 98 |
| 7 | synthetic example16 | 60 | e | 40 | 2052 | 14.3 | 122 |
| 8 | synthetic example17 | 50 | b | 50 | 2052 | 8.3 | 249 |
| 9 | synthetic example18 | 60 | h | 40 | 2052 | 19.0 | 108 |
| 10 | synthetic example19 | 50 | f | 50 | 1098 | 30.1 | 37 |
| 11 | synthetic example20 | 100 | None | — | 1524 | 31.1 | 61 |
| 12 | synthetic example21 | 40 | i | 60 | 512 | 24.1 | 21 |

Table 4 shows the numbers of synthetic examples used for cement additives, numbers of the polycarboxylic acid series copolymers of component “C”, molecular weights of polyoxyalkylene sites of esterified polycarboxylic acid series copolymers for component (A), amine values of solution mainly consisting of component (A), and values of (molecular weight of polyoxyalkylene sites of esterified polycarboxylic acid series copolymers of component (A)/amine value of solution mainly consisting of component (A)) in composition examples.

(Method of Measurement of Amine Value)

A sample is precisely weighed in a beaker, to which neutral ethanol (ethyl alcohol (99.5 V/V %) is neutralized with N/2 hydrochloric acid standard solution using bromcresol green indicator direct before the use) is added to dissolve the sample. Several drops of bromcresol green indicator was added to the solution to titrate with N/2 hydrochloric acid. The end point is determined at the moment when the color of the solution was changed from green to yellow. The amine value is calculated according to the following equation.
Amine value=(28.05×F×A)/W

A: used amount of N/2 hydrochloric acid standard solution

F: factor of N/2 hydrochloric acid standard solution

W: weight of taken sample (g)

### Composition Example 1

400 grams of the compound synthesized in the synthetic example 10 and 600 grams of the copolymer “a” of component “C” were weighed, charged into 2-liter flask equipped with a mixer, thermometer and tube for introducing nitrogen gas, and mixed with stirring for 30 minutes at a temperature higher than the freezing point of the solution. The thus obtained solution had an amine value of 15.9. after that, ion exchange water was added to obtain 60% aqueous solution.

### Composition Examples 2 to 12

Compounds synthesized in synthetic examples 11 to 21 and copolymers of component (C) (taken as 60% aqueous solution in copolymers “e”, “h” and “i”) were mixed according to compositions shown in table 4 and the same procedure as the composition example 1 and the amine value was measured. The amine value of the thus obtained solution was shown in table 4. In compositions using the copolymers “e”, “h” and “i”, the amine value was measured after the solution was dehydrated.

The additives for cement according to the above composition examples were used to perform slump test and measurement of viscosity as described below. The experimental results were shown in tables 5, 6, 7 and 8.

TABLE 5

| | | 20° C. | | | | | 30° C. | | | | |
|---|---|---|---|---|---|---|---|---|---|---|---|
| | | | slump (cm) | | | | | slump (cm) | | | |
| | | added | direct | | | | added | direct | | | |
| | cement | amount | after | 30 | 60 | 90 | amount | after | 30 | 60 | 90 |
| | additive | (C × %) | mixing | minutes | minutes | minutes | (C × %) | mixing | minutes | minutes | minutes |
| example 1 | composition | 1.50 | 19.4 | 19.8 | 20.2 | 20.0 | 1.45 | 19.8 | 20.0 | 19.6 | 19.0 |
| | example 1 | | | | | | | | | | |
| example 2 | composition | 1.50 | 19.2 | 19.7 | 20.3 | 20.0 | 1.45 | 20.3 | 20.4 | 19.7 | 19.0 |
| | example 2 | | | | | | | | | | |
| example 3 | composition | 1.50 | 19.9 | 20.4 | 20.9 | 20.5 | 1.45 | 20.2 | 20.5 | 20.0 | 19.6 |
| | example 3 | | | | | | | | | | |
| comparative | composition | 1.55 | 19.0 | 20.0 | 19.5 | 19.0 | 1.50 | 20.2 | 18.6 | 17.0 | 15.4 |
| example 1 | example 4 | | | | | | | | | | |

TABLE 6

| | | 20° C. | | | | | 30° C. | | | | |
|---|---|---|---|---|---|---|---|---|---|---|---|
| | | | slump (cm) | | | | | slump (cm) | | | |
| | | added | direct | | | | added | direct | | | |
| | cement | amount | after | 30 | 60 | 90 | amount | after | 30 | 60 | 90 |
| | additive | (C × %) | mixing | minutes | minutes | minutes | (C × %) | mixing | minutes | minutes | minutes |
| example 4 | composition | 1.50 | 19.5 | 19.7 | 20.0 | 19.8 | 1.45 | 20.0 | 20.3 | 19.6 | 19.0 |
| | example 5 | | | | | | | | | | |
| example 5 | composition | 1.50 | 19.3 | 19.8 | 20.2 | 20.0 | 1.50 | 20.2 | 20.4 | 19.9 | 19.2 |
| | example 6 | | | | | | | | | | |
| example 6 | composition | 1.50 | 19.6 | 20.0 | 20.4 | 20.2 | 1.50 | 20.1 | 20.4 | 19.8 | 19.4 |
| | example 7 | | | | | | | | | | |
| comparative | composition | 1.55 | 19.1 | 20.1 | 19.6 | 19.0 | 1.55 | 20.0 | 18.3 | 16.6 | 14.9 |
| example 2 | example 8 | | | | | | | | | | |

TABLE 7

| | | 20° C. | | | | | 30° C. | | | | |
|---|---|---|---|---|---|---|---|---|---|---|---|
| | | | slump (cm) | | | | | slump (cm) | | | |
| | | added | direct | | | | added | direct | | | |
| | cement | amount | after | 30 | 60 | 90 | amount | after | 30 | 60 | 90 |
| | additive | (C × %) | mixing | minutes | minutes | minutes | (C × %) | mixing | minutes | minutes | minutes |
| example 7 | composition | 1.50 | 19.5 | 19.7 | 20.0 | 19.8 | 1.45 | 20.2 | 20.6 | 20.0 | 19.2 |
| | example 9 | | | | | | | | | | |
| example 8 | composition | 1.50 | 19.3 | 19.8 | 20.2 | 20.0 | 1.45 | 20.0 | 20.4 | 19.8 | 19.1 |
| | example 10 | | | | | | | | | | |
| example 9 | composition | 1.50 | 19.6 | 20.0 | 20.4 | 20.2 | 1.45 | 20.0 | 20.5 | 20.0 | 19.0 |
| | example 11 | | | | | | | | | | |
| example 10 | composition | 1.50 | 18.9 | 19.5 | 20.1 | 19.8 | 1.45 | 20.0 | 20.4 | 20.0 | 19.2 |
| | example 12 | | | | | | | | | | |

### Example 1

The solution of the cement additive obtained in composition example 1 was diluted with ion exchange water to adjust the content of aqueous solution at 20 weight percent, to which an anti foaming agent (“DISFOAM CC-118” supplied by NOF CORPORATION) was added. Concrete was prepared in a laboratory at room temperature of 20° C. or 30° C. as follows. 10.9 kg of cement (ordinary portland cement), 26.0 kg of fine aggregates (river sands from Ooi river; specific gravity of 2.60) and 28.9 kg of coarse aggregates (crushed stones from Oume: specific gravity of 2.66) were supplied into a 50-liter forced biaxial mixing type mixer to perform dry mixing for 15 seconds. After that, the above additive for cement was added to the mixture in an amount of 164 grams at 20° C. or 153 grams at 30° C. with 4.4 kg of civil water and mixed for 2 minutes. The amount was controlled so that the slump of the composition direct after the mixing is 20±1 cm. The composition was discharged to a vat for retempering to measure the slumps of the composition direct, 30 minutes, 60 minutes and 90 minutes after the mixing. It was confirmed that air content was 4.5±1.0% and the temperature was 20±2° C. or 30±2° C. between time points direct after and 90 minutes after the mixing. The results were shown in table 5. Column of “added amount” indicates that as 20% aqueous solution.

### Examples 2 to 10

Solutions of additives for cement obtained according to composition examples 2, 3, 5 to 7 and 9 to 12 were used to perform the tests of concrete according to the same procedure as the example 1 and added amounts shown in tables 5, 6 and 7. The thus obtained results were shown in tables 5 to 7.

### Comparative Examples 1 and 2

Solutions of copolymers obtained in compositions 4 and 8 were used to perform the tests of concrete, according to the same procedure as the example 1 and added amounts shown in tables 5 and 6. The thus obtained results were shown in tables 5 and 6.

According to the above results, the cement additives according to the examples 1 to 10 of the present invention have superior water reducing property compared with that of the cement additives of comparative examples 1 and 2. It is proved that desired fluidity can thereby be maintained 90 minutes after the mixing even at a high temperature.

For example, referring to table 5, according to the inventive examples 1, 2 and 3, slump at 20° C. has a peak at a time point of more than 60 minutes after the mixing and is larger than 20 cm until 90 minutes after the mixing. According to the comparative example 1, although slump has a peak at a time point of more than 30 minutes after the mixing, the peak is small and slump is 19.0 cm even at 90 minutes after the mixing. The improvement of slump loss by the cement additives of the inventive examples 1 to 3 was relatively small at 20° C. Contrary to this, when the cement additive of comparative example 1 was used at 30° C., the slump takes a peak value direct after the mixing and is continuously lowered to about 15 cm until a time point of 90 minutes after the mixing. Contrary to this, according to the inventive examples 1, 2 and 3, slump takes a peak at a time point of more than 30 minutes after the mixing and is higher than 19.0 cm even at 90 minutes after the mixing. The effects of prevention of slump loss at 30° C. according to the present invention proved to be considerable compared with that in the comparative example, and could not be predicted based on the data at ambient temperature (20° C.).

The results shown in table 6 was substantially the same as those described above.

TABLE 8

| | | added | slump direct | evaluation |
|---|---|---|---|---|
| | cement | amount | after mixing | of viscosity |
| | additive | (C × %) | (cm) | average |
| example 11 | composition | 1.50 | 20.0 | 1.3 |
| | example 2 | | | |
| example 12 | composition | 1.50 | 20.5 | 1.7 |
| | example 7 | | | |
| example 13 | composition | 1.50 | 20.2 | 2.0 |
| | example 9 | | | |
| comparative | composition | 1.55 | 20.3 | 3.0 |
| example 3 | example 4 | | | |
| comparative | composition | 1.55 | 19.8 | 3.7 |
| example 4 | example 8 | | | |

The cement additives shown in table 8 were evaluated for the viscosity.

### Example 11

The cement additive obtained in composition example 2 was prepared according to the same procedure as example 1 with an anti forming agent added. Concrete was prepared in a laboratory at room temperature of 20° C. as follows. 10.9 kg of cement (ordinary portland cement), 25.0 kg of fine aggregates (rough sands from Kimitsu; specific gravity of 2.50) and 29.4 kg of coarse aggregates (crushed stones from Shuhou: specific gravity of 2.71) were supplied into a 50-liter forced biaxial mixing type mixer to perform dry mixing for 15 seconds. After that, the above additive for cement was added to the mixture in an amount of 164 grams with 4.4 kg of civil water and mixed for 2 minutes. The composition was discharged onto a vat for retempering. It was confirmed that the slump of the composition is 20±1 cm and the air content was 4.5±1.0% direct after the mixing. The following items were evaluated by three persons using scoops and the average was calculated to evaluate the viscosity. The results were shown in table 8.

(Evaluation of Viscosity)

Mixed raw concrete was leveled by a scoop and one of the following items was selected.
1: low viscosity: substantially easy to handle
2: low viscosity: easy to handle
3: high viscosity: slightly difficult to handle
4: high viscosity: substantially difficult to handle

### Examples 12 and 13

The cement additives obtained in compositions 7 and 9 were used to prepare additive compositions for cement according to the same procedure as the example 11. After that, concrete was prepared according to the same procedure as the example 11, and the viscosity was evaluated using a scoop. The results were shown in table 8.

### Comparative Examples 3 and 4

The cement additives obtained in compositions 4 and 8 were used to prepare additive compositions for cement according to the same procedure as the example 11. After that, concrete was prepared according to the same procedure as the example 11, and the viscosity was evaluated using a scoop. The results were shown in table 8.

As shown in the above results, the cement additives used in the inventive examples 11 to 13 exhibit the effect of considerably lowering the viscosity of the cement composition compared with those used in the comparative examples 3 and 4. The working efficiency of the cement composition can thus be improved.

As described above, the present invention provides a cement additive so that slump loss at high temperature can be prevented over a long period of time, the viscosity of raw concrete or the like produced can be lowered, and the working efficiency of the cement composition can be improved.

1. An additive for cement comprising the following component (A).
(A) A polycarboxylic acid series esterified copolymer obtained by esterifying a part or whole of carboxylic acid groups of a polycarboxylic acid series copolymer having a polyoxyalkylene chain with a derivative of an alcohol having a polyoxyalkylene chain and represented by the following formula (1), 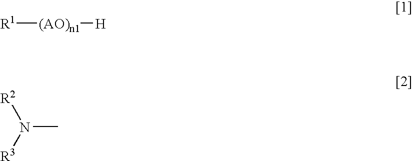
(R¹ represents a group of a heterocyclic ring having a nitrogen atom or a group represented by the above formula (2), R² and R³ represent hydrocarbon groups having 1 to 6 carbon atom(s), respectively and independently, “AO” represents an oxyalkylene group having 2 to 4 carbon atoms, and “n1” represents an average mole number of addition of said oxyalkylene group and 1 to 8)

2. The additive for cement of claim 1, wherein the molecular weight of the polyoxyalkylene site of said polycarboxylic acid series copolymer and the amine value of said component (A) satisfy the following formula (3a).
Molecular weight of polyoxyalkylene site of polycarboxylic acid series copolymer/amine value of component (A)=15 to 150 (3a)

3. The additive for cement of claim 1, wherein said polycarboxylic acid series esterified copolymer of said component (A) comprises a copolymer comprising, as essential monomers,
(a) a polyoxyalkylene derivative represented by the following formula (4),
R⁴O(AO)ⁿ²R⁵ (4)
(In the formula, R⁴ represents an unsaturated hydrocarbon group having 2 to 8 carbon atoms, R⁵ represents hydrogen atom or a saturated hydrocarbon group having 1 to 8 carbon atom(s), “AO” represents an oxyalkylene group having 2 to 4 carbon atoms, and “n2” represents an average mole number of addition of said oxyalkylene group and 10 to 100.), and
(b) an unsaturated polyvalent carboxylic acid series compound.

4. The additive for cement of claim 3, wherein R⁵ represents hydrogen atom or a saturated hydrocarbon group having 1 to 4 carbon atom(s) and said oxyalkylene group constituting AO comprises an oxyethylene group in a ratio of 50 mole % or more.

5. The additive for cement of claim 3, wherein said unsaturated polyvalent carboxylic acid series compound comprises a maleic acid series compound.

6. An additive composition for cement comprising the additive for cement of claim 1 and the following component (B).
(B) A derivative of an alcohol having polyoxyalkylene and represented by the following formula (1) 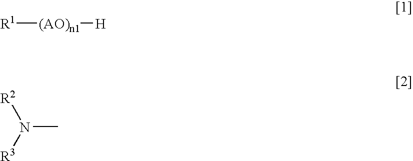
(R¹ represents a group of a heterocyclic ring having a nitrogen atom or a group represented by the above formula (2), R² and R³ represent hydrocarbon groups having 1 to 6 carbon atom(s), respectively and independently, “AO” represents an oxyalkylene group having 2 to 4 carbon atoms, and “n1” represents an average mole number of addition of said oxyalkylene group and 1 to 8)

7. The additive composition for cement of claim 6, wherein the molecular weight of the polyoxyalkylene site of said polycarboxylic acid series copolymer and the amine value of a mixture of said components (A) and (B) satisfy the following formula (3b).
Molecular weight of polyoxyalkylene site of said polycarboxylic acid series copolymer/amine value of a mixture of said components (A) and (B)=15 to 150 (3b)

8. The additive composition for cement of claim 6, further comprising the following component (C).
(C) A polycarboxylic acid series copolymer comprising a polyoxyalkylene chain

9. The additive composition for cement of claim 8, wherein the molecular weight of the polyoxyalkylene site of said polycarboxylic acid series copolymer as a material of said component (A) and the amine value of a mixture of said components (A), (B) and (C) satisfy the following formula (3c).
Molecular weight of polyoxyalkylene site of said polycarboxylic acid copolymer as a material of said component (A)/amine value of a mixture of said components (A), (B) and (C)=15 to 150 (3c)

10. An additive composition for cement comprising the additive for cement of claim 1 and the following component (C).
(C) A polycarboxylic acid series copolymer comprising a polyoxyalkylene chain

11. The additive composition for cement of claim 10, wherein the molecular weight of the polyoxyalkylene site of said polycarboxylic acid series copolymer as a material of said component (A) and the amine value of a mixture of said components (A) and (C) satisfy the following formula (3d).
Molecular weight of polyoxyalkylene site of polycarboxylic acid series copolymer as a material of said component (A)/amine value of a mixture of said components (A) and (C)=15 to 150 (3d)
